(19) United States
(12) Patent Application Publication
(10) Pub. No.: US 2023/0294065 A1
(43) Pub. Date: Sep. 21, 2023

(54) METHOD AND SYSTEM FOR TRANSFORMING A GAS MIXTURE USING PULSED PLASMA

(71) Applicants: Centralesupelec, Gif-Sur-Yvette (FR); CENTRE NATIONAL DE LA RECHERCHE SCIENTIFIQUE, Paris (FR)

(72) Inventor: Erwan Pannier, Paris (FR)

(21) Appl. No.: 17/999,304

(22) PCT Filed: May 20, 2021
(86) PCT No.: PCT/FR2021/050900

§ 371 Date: Apr. 7, 2023

(30) Foreign Application Priority Data
May 20, 2020 (FR) FR2005313

(51) Int. Cl. B01J 19/08

(52) U.S. Cl. CPC B01J 19/088; B01J 2219/0894; B01J 2219/0809; B01J 2219/0815; B01J 2219/0845; B01J 2219/0869; B01J 2219/00759

(57) ABSTRACT

Method for transforming a gas mixture into a gas mixture of higher added value, comprising a step of injecting a gas mixture into a pulsed plasma reactor, a dissociation step using pulsed discharges to generate a shock wave between two electrodes to produce gases, and a step of releasing the produced gases to an area where they can be cooled down and/or separated and/or collected. The dissociation step is also designed to provide passive re-ignition of the plasma in the event that the latter is blown out by the continuous stream of gas in the reactor.

### CROSS-REFERENCE TO RELATED APPLICATIONS

This application is a national phase entry under 35 U.S.C. § 371 of International Patent Application PCT/FR2021/050900, filed May 20, 2021, designating the United States of America and published as International Patent Publication WO 2021/234302 A1 on Nov. 25, 2021, which claims the benefit under Article 8 of the Patent Cooperation Treaty to French Patent Application Serial No. FR2005313, filed May 20, 2020.

### TECHNICAL FIELD

The present disclosure belongs to the field of gas production devices, and, in particular, reforming devices for the production of products of higher added value.

### BACKGROUND

Plasma discharges present an electrophysical alternative to the transformation of gas mixtures into gas mixtures of higher added value by thermal approaches (pyrolysis), thermocatalytic approaches (reforming reactions), or electrochemical approaches (electrolysis).

Document U.S. Pat. No. 6,395,197 B1 discloses a method and system for producing hydrogen and elemental carbon from natural gas and other hydrocarbons. Diatomic hydrogen and unsaturated hydrocarbons are produced as reactor gas in a fast quench plasma reactor. During fast quenching, the unsaturated hydrocarbons are further decomposed by heating the reactor gases. Other gases can be added at different stages of the process to form a desired final product and prevent back-reactions. The product is a hydrogen fuel and elemental carbon that can be used in powder form as a feedstock for a number of industrial processes.

Document U.S. Pat. No 5,409,784 discloses a plasmatron-fuel cell system for generating electricity, wherein the plasmatron receives a hydrocarbon fuel and reforms the hydrocarbon fuel to produce a hydrogen-rich gas.

The use of pulses makes it possible to produce plasmas with an equivalent density of reactive species while reducing the heating compared to non-pulsed plasmas. The energy efficiency of the method is improved.

In the case where these methods use plasma discharges in high-velocity gas streams, the gas residence time may become comparable to or less than the characteristic ionization times. In this case, the chemical reaction might not occur, and the plasma might not ignite.

Active systems are already known to ignite the plasma, which make it possible to increase the electric field above the breakdown value. These active systems can use an increase of the voltage applied to the electrodes, a decrease of the gas pressure, an increase of the gas temperature, or a decrease of the inter-electrode distance by a mobile mechanical system.

These active systems presented above have industrial limitations. They are not suitable for pulse-generated plasmas, which means it is not possible to benefit from their advantageous energy efficiency. Indeed, the decrease of the pressure and the increase of the temperature require an interruption of the process. The increase of the voltage requires an oversizing of the voltage generator (additional cost). The presence of moving parts leads to additional maintenance and sealing costs. Moreover, feedback systems require sensors, thus measurement systems (electrical measurement, optical measurement) and a processing circuit for feedback.

Document WO 2013/078880 A1 discloses a multi-stage plasma reactor system including (i) hollow cathodes for cracking carbonaceous material, each stage comprising hollow cathodes and hollow anodes cooled by recycling cooling agent or refrigerant fluid, (ii) one or more working gas inlets, (iii) one or more inlets for carbonaceous material and carrier gas as feedstock, and (iv) reaction tubes connected to the anode or to the cathode.

Document CN 109663555 A discloses a system and a method for synergistically converting greenhouse gas and biochar by pulsed jet plasma. A discharge arc formed between an inner and an outer electrode is driven by an ascending CO2 spiral airflow and sequentially passes through a tapered nozzle and an air distribution plate to form a plurality of uniformly distributed plasma microjets. The microjets drive the biochar particles to form a gas-solid fluidization reaction area.

The purpose of the present disclosure is to propose a method and system for pulsed plasma gas transformation that allows better operational continuity and lower maintenance costs than current methods and systems.

### BRIEF SUMMARY

This objective is achieved with a method for producing gases from a gas mixture comprising:
a step of injecting a gas mixture into a pulsed plasma reactor,
a dissociation step of the gas mixture, using isochoric discharges between a first long electrode, of a given polarity, and one or more other electrodes of opposite polarity, facing the first electrode,
a step of releasing the produced reactive gases from the dissociation step to an area where they can be cooled down and/or separated and/or collected.

According to the present disclosure, the first electrode and the one or more other electrodes define an inter-electrode gap characterized by a variable inter-electrode distance and formed of an ignition area and two other areas, and the dissociation step comprises, in the event that the plasma produced in the reactor is blown out by a continuous stream of gas in the reactor, a step for providing passive re-ignition of the plasma, the passive re-ignition step being performed in an ignition area providing an area protected from the continuous stream of gas and having an inter-electrode distance allowing ignition of the plasma sheltered from the continuous stream of gas.

The re-ignition technique used in the system/method according to the present disclosure is passive and therefore reliable.

It should be noted that this configuration of the dissociation reactor could also be used in plasma-assisted combustion chambers for which the control of the reactive area in high-flow media can pose a real problem.

The passive re-ignition of the plasma can further advantageously comprise, at the outlet of the ignition area (1), an entry of the plasma into a propagation area having an increasing inter-electrode distance (2) and then decreasing inter-electrode distance (3) in the direction of propagation of the plasma, and then into a stable operating area (4) arranged to create an electric field and having an inter-electrode distance less than the distance in the propagation area.

The passage from the area (1) to the area (2) then (3) is obtained advantageously by using the flow induced by discharges producing a shock wave, referred to as isochoric discharges. This shock wave is created passively by the isochoric discharges.

Another problem solved in the gas transformation method according to the present disclosure is the need to control the gas flow within the plasma reactor.

The inflow of gas (overall flow) is transformed by passing through a reactive area (a reaction transforms the incoming materials into products), which generates its own flow (induced flow). If the products of the reaction are convected upstream of the overall flow, they can be transformed again in the reactive area, and the energy efficiency drops.

These isochoric discharges produced during the dissociation step between the first electrode of given polarity and the other electrode of opposite polarity generate an asymmetric shock wave that contributes to control of the direction of the flow of the reactive gases in the plasma discharge.

In a preferred embodiment according to the present disclosure, the shock waves are obtained by repetitive pulsed nanosecond discharges, produced between the first electrode of given polarity and the other electrode or electrodes of opposite polarity or neutral.

The direction control may advantageously comprise an increase in a reduced electric field at one of the two electrodes.

A heating included in one of the electrodes could also be provided to produce a reduced electric field asymmetry.

The shock wave caused by the pulsed discharge and the associated hydrodynamic expansion have been the subject of several scientific works [1] [2] [3]. The novelty of the method according to the present disclosure lies in the stability of the flow control obtained.

It is noted that the ignition of a plasma is driven by the reduced electric field E/N, where E is the electric field and N the number of molecules per unit of volume. E/N is expressed in Townsends (1 Td=10⁻¹⁷ V·cm²).

The hydrodynamics generated by a shock wave can take two forms:
a diffusive regime
a non-diffusive regime, with the presence of an ejection of hot gases produced by the discharge.

In the present disclosure, the regime must be non-diffusive. Dumitrache's theory [5] provides a criterion for achieving a non-diffusive regime, which depends on the dimensionless number π:

$$π such that \frac{E}{d π {R}^{2} P} > 60$$

where E is the energy deposited in thermal form in the plasma, d is the inter-electrode distance, R is the radius of the discharge, and P is the gas pressure.

In the non-diffusive regime, the discharge creates a shock wave that can be modeled by a cylindrical shock wave centered on the inter-electrode axis, and two spherical shock waves substantially centered in front of each of the electrodes. Under axisymmetric initial conditions, the spherical shock waves diffuse with the same velocity and the hot gases are ejected along a torus. Under non-symmetric initial conditions, one of the two shock waves is faster and the hot gases are ejected on the side of the faster shock wave.

The propagation speed of a shock wave is proportional to the pressure gradient. In an isochoric discharge (energy deposition<<hydrodynamic times), the pressure gradient is proportional to the temperature gradient at the end of the discharge. In isochoric discharges, the temperature increase is due to the predissociation of excited electronic states (ultrafast heating).

The excitation of electronic states increases with the reduced electric field E/N. Therefore, if one of the two electrodes is initially hotter, the reduced electric field will be higher. Consequently, the excitation and therefore the predissociation will be higher. Consequently, the temperature in the discharge will be higher, and thus the pressure, and so the shock wave will be faster at this electrode. Consequently, the hot gases will be ejected from the side of the hot electrode. The electrode will remain hot, hence the stability.

In a particular exemplary embodiment of the present disclosure, the heating of one of the electrodes is produced directly by the impact of the ions on the electrode and by the reduction of thermal diffusion. The heating of one of the two electrodes can be increased by choosing for this electrode a material with low thermal diffusivity.

To understand the mechanisms controlling the flow induced by a single nanosecond discharge generated between a pair of electrodes and leading to the formation of the two hydrodynamic regimes observed, it may be useful to refer to document [6].

To understand the impact of the recirculation of gas flows on the temporal development of the species and the temperature of the gases in the vicinity of the discharge area generating a shock wave, it may be useful to refer to document [7].

For a numerical study of the fluid dynamics induced by the plasmas produced by two laser pulses for the ignition of combustible mixtures, it may be useful to refer to document [8].

In the method, the geometry and thermophysical properties of the electrodes are controlled to generate the induced flow and to convectively direct the outgoing gases away from the reactive area and downstream of the overall flow.

A novel approach is also proposed for the generation of voltage signals applied to the electrodes of the plasma reactor using the gas transformation method according to the present disclosure.

Indeed, it is known that plasmas are characterized by the reduced electric field (E/N) applied in the discharge (expressed in Townsends: Td). Different types of plasma (microwave, nanosecond, DBD, etc.) correspond to different ranges of reduced electric fields. Each range of reduced electric field corresponds to a different excitation mode of the molecule.

The dissociation of molecules (CO2, hydrocarbons) by plasma requires both a generation of a sufficient density of electrons and an excitation of these electrons at the vibrational energies of the molecules.

The production of electrons is obtained by ionization at strong electric fields (>130 Td). The vibration of molecules is obtained for intermediate electric fields (50-100 Td).

The aim is to combine different signals in an efficient way to obtain a strong ionization followed by a vibration of the molecules by combining an electric pulse of reduced field >130 Td followed by an electric pulse of intermediate field (50-100 Td).

The dissociation step may further comprise a step for generating a high-voltage signal for controlling repetitive discharges by combining a very-high-voltage signal over short times to ionize the gas and a high-voltage signal over medium times to excite the molecules into excited vibrational levels.

According to another aspect of the present disclosure, there is proposed a system for transforming a gas mixture, using the production method according to the present disclosure, comprising:
a pulsed plasma reactor,
means for injecting a gas mixture into the pulsed plasma reactor,
a dissociation stage comprising the pulsed plasma reactor receiving the inflow of gas at the inlet, a first long electrode of a given polarity, and one or more other electrodes of opposite polarity, facing the first electrode, the first electrode and the one or more other electrodes (i) defining an inter-electrode gap, characterized by a variable inter-electrode distance, and (ii) arranged so as to subject the flow of gas to isochoric discharges so as to produce reactive gases,
an interface for releasing the reactive gases to an area where they can be cooled and/or separated and/or collected,
   characterized in that the pulsed plasma reactor comprises an area protected from the flow of gas, a so-called ignition area, the inter-electrode distance of which allows a passive re-ignition of the plasma in the event that the latter is blown out by a continuous stream of gas in the plasma reactor.

The pulsed plasma reactor according to the present disclosure may advantageously comprise:

an area of increasing inter-electrode distance and then decreasing inter-electrode distance in the direction of propagation of the plasma, known as the propagation area, and
an area of inter-electrode distance less than the distance in the propagation area, known as the stable operation area, arranged to create an electric field.

The isochoric discharges produced between the first electrode of given polarity and the other electrode or electrodes of opposite polarity generate a shock wave that contributes to controlling the direction of the reactive gases.

The first electrode may advantageously have a point effect arranged so as to generate, in the stable operation area, a reduced electric field greater than that generated in the ignition area or in the propagation area.

The stable operation area may be either substantially parallel to the direction of the gas flow, or substantially transverse to the direction of the gas flow.

In this transverse configuration, and if a horizontally arranged reactor is considered, the gas flow can be either perpendicular to a substantially horizontal plane through the electrodes or perpendicular to a substantially vertical plane through the electrodes.

In a preferred configuration of the present disclosure, the transformation system may further comprise means for controlling the direction of flow of the reactive gases in the plasma discharge, the direction control means comprising means for increasing the reduced electric field at one of the two electrodes.

The means for increasing the reduced electric field can use a point-effect electrode and/or a heating mechanism included in one of the electrodes.

The transformation system according to the present disclosure may further comprise means for generating a high-voltage signal greater than 10 kV for controlling repetitive discharges by combining a very-high-voltage signal greater than 130 Td over short times less than 20 ns to ionize the gas and a high-voltage signal between 50 and 100 Td over long times less than 1 s to excite the molecules into excited vibrational levels.

According to yet a further aspect of the present disclosure, use of the system according to the present disclosure to produce gaseous dihydrogen from hydrocarbon and CO2 mixtures or hydrocarbons is proposed, comprising an injection of the hydrocarbon and CO2 mixtures or of hydrocarbons at the inlet of the pulsed plasma reactor, and a collection of gaseous dihydrogen at the outlet of the pulsed plasma reactor.

The isochoric discharges may advantageously comprise nanosecond repetitively pulsed (NRP) discharges.

The interface for releasing the reactive gases may comprise:
a stage for rapid cooling of the reactive gases,
a stage for separating the gaseous dihydrogen and carbon monoxide produced after the cooling of the reactive gases.

According to yet a further aspect of the present disclosure, use of the system according to the present disclosure to produce oxygen from carbon dioxide is proposed, comprising an injection of carbon dioxide at the inlet of the pulsed plasma reactor and a collection of oxygen at the outlet of the pulsed plasma reactor.

### BRIEF DESCRIPTION OF THE DRAWINGS

The present disclosure will be better understood in the light of the description illustrated by the following figures:

FIG. 1 is an overview of a dihydrogen production system according to the present disclosure;

FIG. 2 is a cross-sectional view of an exemplary embodiment of a dihydrogen production system according to the present disclosure;

FIG. 3 is a larger view of FIG. 2, illustrating the key components of the system;

FIG. 4 is a partial cross-sectional view of an exemplary embodiment of a dissociation stage in a dihydrogen production system according to the present disclosure;

FIG. 5A is a partial cross-sectional view of a first configuration of the dissociation stage, in which the stable area is transverse to the gas flow;

FIG. 5B is a partial cross-sectional view of a second configuration of the dissociation stage, in which the stable area is transverse to the gas flow;

FIG. 6 illustrates the various locations of the ignition, propagation and stability areas within a dissociation stage;

FIG. 7 is an enlarged cross-sectional view of a dissociation stage, representing characteristic inter-electrode distances;

FIG. 8 illustrates three examples of characteristic profiles providing inter-electrode distance variations within a dissociation stage;

FIG. 9 illustrates schematically the phenomenon of re-injection of hot gases into the plasma within a reactor;

FIG. 10 is a partial cross-sectional view of a dissociation stage configured to avoid this re-injection phenomenon;

FIGS. 11A-11C illustrates three exemplary embodiments of axial electrodes adapted to avoid this re-injection phenomenon;

FIG. 12 is an overview of a device for generating a mixed signal for feeding the electrodes of a dihydrogen production system according to the present disclosure; and

FIG. 13 is an electrical diagram of a practical exemplary embodiment of the generating device of FIG. 12.

### DETAILED DESCRIPTION

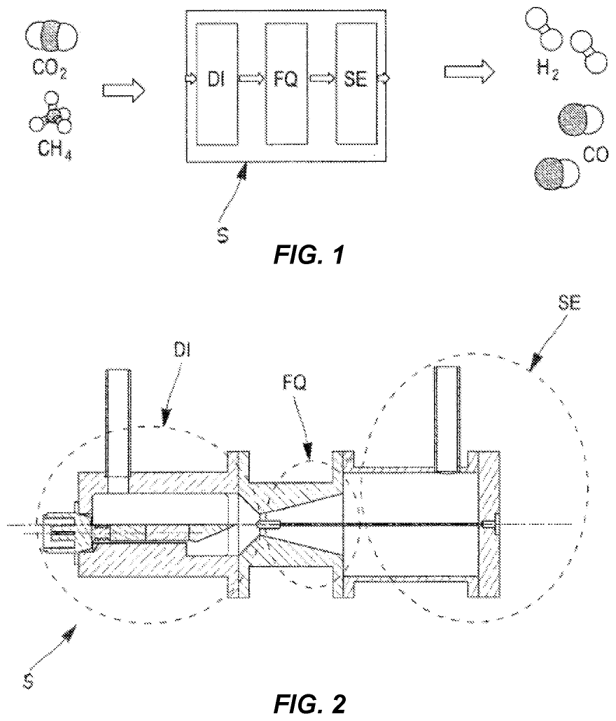

A system S for producing dihydrogen gas according to the present disclosure comprises, with reference to FIGS. 1 and 2, a dissociation stage DI receiving at the inlet a gaseous flow such as a mixture of methane CH₄ and carbon dioxide CO₂, an ultra-rapid cooling stage FQ (“Fast Quenching”), followed by a separation stage SE of the dihydrogen gas H2 and the carbon monoxide gas CO.

By way of practical example, the gas flow processed by this production system may be about 0.2 m³/hr or ˜3.5 liters/min.

For the stoichiometry of the gaseous inputs CO2:CH4, a ratio 50:50 to 30:70 corresponding to a biogas type mixture can be provided; and 0:100 for pure methane.

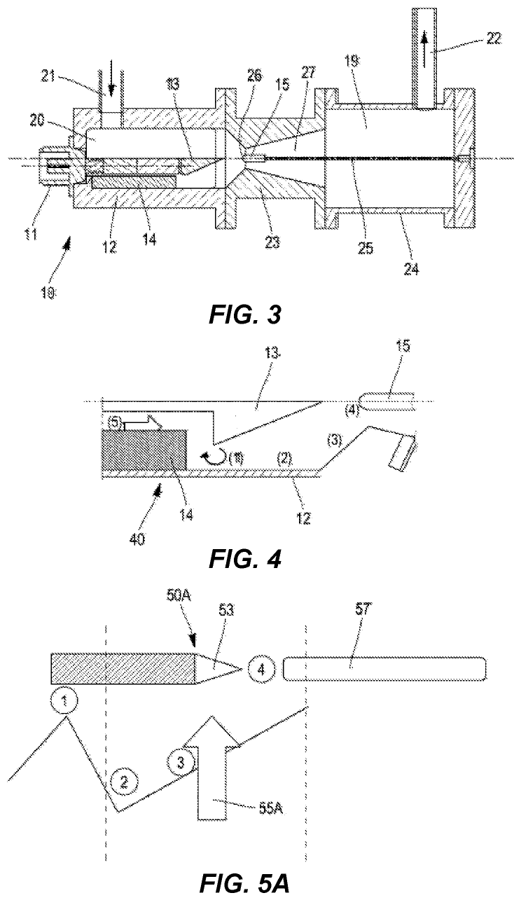

With reference to FIG. 3, a practical exemplary embodiment of a dihydrogen gas production system according to the present disclosure will now be described.

The dissociation stage 10 comprises a structure 12, cylindrical in shape and made of a stainless steel/aluminum alloy, having an inlet 21 for a gas inflow (CH₄, CO₂) and defining a first chamber 20 containing a first electrode 13 acting as an anode facing a second electrode 15 acting as a cathode arranged in the middle of an outlet opening 26 of the first chamber 20. This cathode can be made of tungsten. The dissociation stage 10 is also provided with a connector 11 that contains a supply cable for the electrode 13. The structure 12 contains an insulating block 14 arranged to avoid any occurrence of an electric arc due to the high-voltage supply of the electrode 13.

The outlet opening 26 allows dissociated gases to enter the cooling area FQ formed of a second chamber 27 defined by a structure 23 with a cylindrical outer shape and a conical inner shape providing a continuous increase in the inner diameter of flow from the opening 26 to the outlet of the cooling area FQ.

With reference to FIGS. 2 and 3, the third stage SE of the dihydrogen gas production system 1 comprises a cylindrical structure 24 mechanically coupled to the outlet of the cooling stage FQ and a radial discharge duct 22. The separation chamber 19 inside the structure 24 is axially crossed by an electrical supply rod 25 having at its end the electrode 15 extending into the dissociation chamber 20.

Practical exemplary embodiments of the dissociation stage of a dihydrogen gas production system according to the present disclosure will now be described with reference to FIGS. 4 to 8.

This dissociation stage 40 comprises an anode 13 having a tapered and pointed shape at its end and a cathode 15, facing the anode 13, having a substantially rounded end and electrically connected to the inner wall of the dissociation chamber.

With reference to FIGS. 4 and 6, three characteristic areas can be identified within the dissociation stage: a so-called ignition area 1, AMO corresponding to a minimum inter-electrode distance, a propagation start area 2 where the plasma is just after ignition and in which the inter-electrode distance is increasing in the direction of plasma propagation, then a propagation area 3, PRO, in which the inter-electrode distance is decreasing, followed by a stability area 4, STA located between the tip of the anode 13 and the end of the cathode 15.

The insulating block 14, located upstream of the ignition area 1, has two functions: it prevents the occurrence of an electric arc and it creates this area 1 protected from the continuous stream of gas 5 in which the ignition will take place.

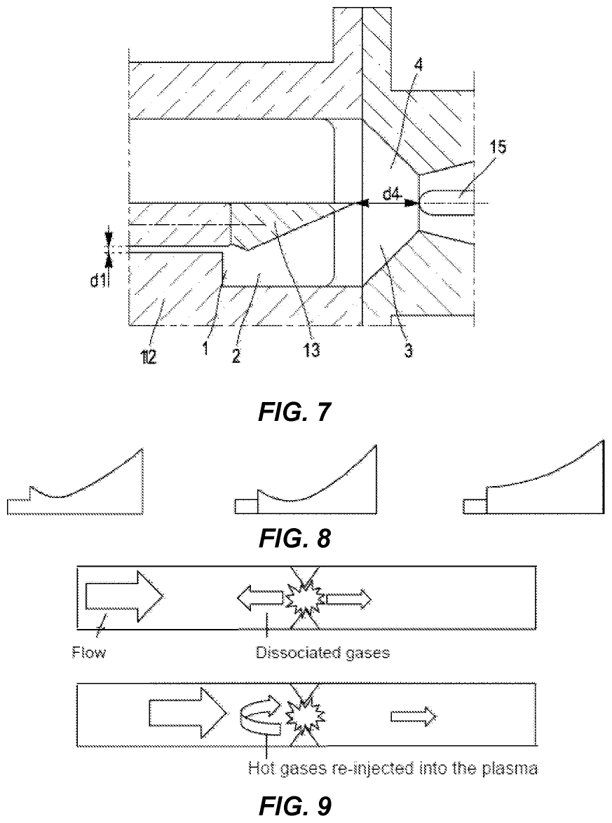

As illustrated in FIG. 7, the inter-electrode distance is variable, increasing and then decreasing, from a minimum value d1 in the ignition area 1 to a value d4 in the stability area 4 between the tip of the electrode 13 and the end of the electrode 15.

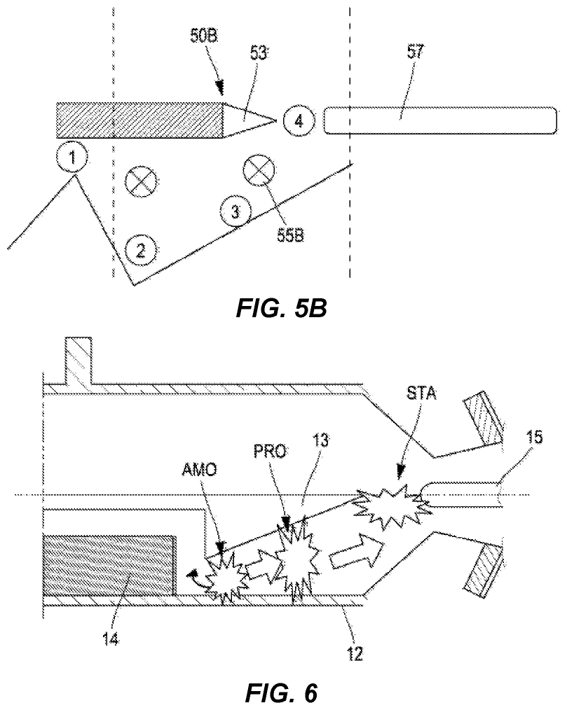

Two configurations of a dissociation stage of a gas transformation system according to the present disclosure, in which the gas stream is transverse to the electrode arrangement, will now be described with reference to FIGS. 5A and 5B.

In a first particular configuration of the dissociation stage 50A of a reactor arranged horizontally, illustrated by FIG. 5A in which the dashed lines delimit the flow area, the gas stream 55A flows perpendicular to the horizontal plane of the electrode arrangement 53, 57. The ignition area 1 is located outside the flow of the stream 55A and is therefore protected from this stream. During discharge in area 1, each spark can cause the induced flow to swing either to the left or to the right. Since the pulse frequency is high (about 1000 pulses per second), it is sufficient to wait for the spark that allows the flow to the right (in the direction of the electrode arrangement 53, 57), for there to be a correct ignition. A small flow bypass can also be provided to drive the plasma toward the electrode arrangement 53, 57. This induced flow will allow the plasma to be placed in the propagation start area 2 in the stream 55A, then the plasma will slowly move over the propagation area 3 to the stability area 4.

In a second particular configuration of the dissociation stage 50B of a horizontally arranged reactor illustrated by FIG. 5B, the gas stream 55B flows perpendicular to the vertical plane of the electrode arrangement 53, 57.

Several profiles of the propagation area can be considered as illustrated in FIG. 8. The efficiency of the profile depends on the ratio d1/d4 and the number 7C (related to the non-diffusive regime), which are chosen as a function of frequency and temperature.

With reference to FIGS. 9 to 11, embodiments of a dihydrogen gas production system according to the present disclosure will now be described, the system making it possible to solve the problem of re-injection of the produced gases into the plasma, as shown schematically in FIG. 9.

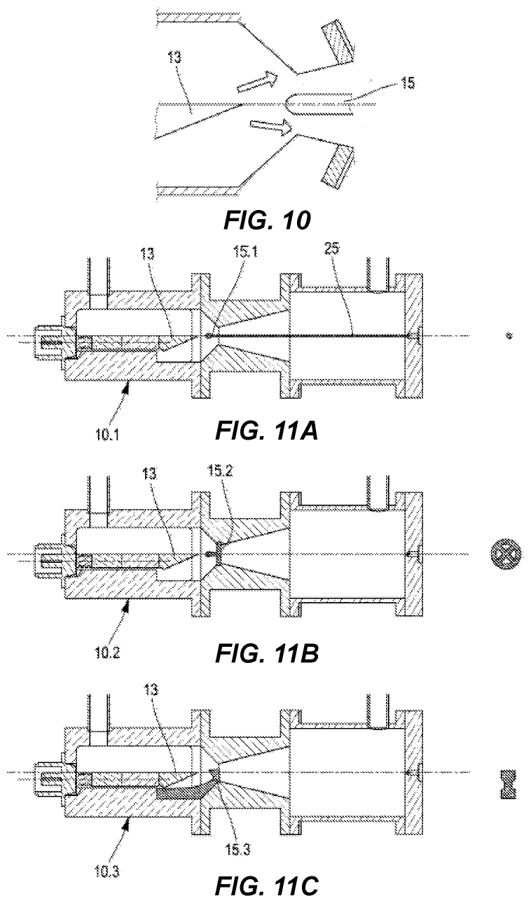

To control the gas flow in the reactor, the gas generation system according to the present disclosure thus comprises:
two electrodes 13, 15 facing each other, as shown in FIG. 10, defining an inter-electrode area in which an electric field is created between the two electrodes to produce a plasma discharge generating a shock wave, hereinafter referred to as an isochoric discharge;
a reactive area in which a high reduced field is promoted at one of the two electrodes, by using a point-effect electrode, with an increase in temperature, by a heating mechanism included in the electrode 13 and by reducing cooling mechanisms around the electrode.

The shock wave is created passively by the isochoric discharges.

Possible geometric profiles for the ignition, propagation and stabilization areas within a pulsed plasma reactor of a gas mixture transformation system according to the present disclosure will now be described.

First, it is important to note that an ideal one-dimensional (1D) propagation pattern is a straight profile forming an angle α with the direction of propagation, with the ideal angle α depending on the pulse frequency and the temperature reached. However, ignition at the beginning must play on the point effect, while stabilization at the end of the process requires reducing the inter-electrode gap.

An ideal theoretical profile [ignition+propagation+stabilization] would therefore be a combination of a point and two broken lines. As such, a theoretical profile is in practice difficult to machine; a profile using the same tangents as this ideal profile was used.

In this context, three cathode geometries designed to provide flow control are shown in FIGS. 11A-11C, with the objective of satisfying the following conditions: not blocking the flow direction, providing a replaceable cathode part, and being easily machinable.

In a first geometry (FIG. 11A), the cathode 15.1 has the form of a point at the end of the rod 25. In a second geometry (FIG. 11B), the cathode 15.2 has the form of a perforated disc arranged in the smaller diameter part of the rapid cooling area. In a second geometry (FIG. 11C), the cathode 15.3 has a complex geometry extending from the ignition area to the stability area. These cathodes 15.2 or 15.3 can be made of tungsten material using additive prototyping machines.

In a preferred mode of operation, the pulsed plasma generating a shock wave is generated by nanosecond repetitively pulsed (NRP) pulses, with a voltage of 10 kV and a repetition rate in the range of 5 to 500 kHz, preferably between 10 and 100 kHz.

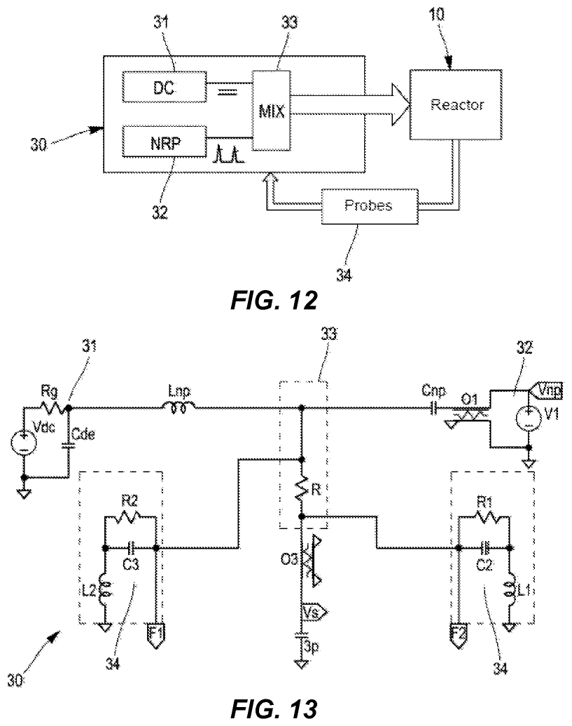

An exemplary embodiment of a system for generating voltage signals that are applied to the plasma reactor electrodes of a gas generation system according to the present disclosure will now be described with reference to FIGS. 12 and 13. The voltage signals result from a combination of variably shaped high-voltage signals for generating plasma discharges, so as to excite different energy modes of a molecule to achieve a desirable chemical effect.

In the signal generation system 30, a very-high-voltage signal (>130 Td) over short times (0-20 ns), referred to as short pulse, is thus combined to ionize the gas with a high-voltage signal (50-100 Td) over long times (0-1 s), referred to as long pulse, to excite the molecules into vibrational levels. The long pulse is generated by a long pulse generator module 31, and the short pulse is generated by an NRP module 32. The two signals are combined with a mixing module 33.

The generation system 30 comprises:
a DC module 31 generating a high-voltage pulse of duration 0-1 s, hereinafter referred to as long pulse, provided with an impedance adaptation,
an NRP module 32 generating a high-voltage pulse of duration 0-20 ns, hereinafter referred to as short pulse, provided with an impedance adaptation,
a module 33 for mixing short and long pulses,
voltage probes 34 providing information about the signals actually applied to the electrodes of the reactor 10.

The long pulse generator module 31 is equipped with a protection realized by a first-order low-pass filter, while the short-pulse generator module 32 is equipped with a protection realized by a second-order high-pass filter.

The short-pulse generator module 32 provides a reduced electric field >100 Td and duration 0-20 ns, while the long pulse generator module 31 provides a reduced electric field of 50-100 Td and duration 0-1 s.

The signal generation system 30 is defined so that the reduced electric field of the long pulse is below the ionization threshold. The plasma is in the subcritical regime.

Kinetic calculations give the following:
optimal E/N field: 50 Td or 4 kV/cm at a temperature of 900 K and 3 kV/cm at a temperature of 1200 K;
target ranges: voltage [1-4 kV] and [0.5-30 A].

In a first example, the long-pulse generator module 31 is a DC generator of voltage 3 kV and of maximum current 1 A, and the short-pulse generator module 32 is a high-voltage NRP generator of voltage 10 kV. The NRP circuit is protected from the DC, and the DC circuit is protected from the NRP.

In another example, the short-pulse generator module 32 is a 10 ns nanosecond pulse generator, and the long-pulse generator module 31 is a 1 μs pulse generator.

The present disclosure is not limited to the exemplary embodiments just described and many other embodiments can be considered without departing from the scope of the present disclosure. In particular, the re-ignition technique set forth in the present disclosure could also be used in a plasma-assisted combustion system or for scramjets (supersonic combustion ramjet).

### REFERENCES

[1] “Experimental study of the hydrodynamic expansion following a nanosecond repetitively pulsed discharge in air” (2011) Da A. Xu, Deanna A. Lacoste, Diane L. Rusterholtz, Paul-Quentin Elias, Gabi D. Stancu, and Christophe O. Laux.

[2] “Simulation of the hydrodynamic expansion following a nanosecond pulsed spark discharge in air at atmospheric pressure” (2013) Fabien Tholin and Anne Bourdon.

[3] Hydrodynamic Regimes Induced by Nanosecond Pulsed Discharges in Air: Mechanism of Vorticity Generation, (2019) Ciprian Dumitrache 1, Arnaud Gallant, Nicolas Minesi, Sergey Stepanyan, Gabi D Stancu and Christophe O Laux.

[4] Dumitrache, C.; Yalin, A. P. Numerical Modeling of the Hydrodynamics Induced by Dual-Pulse Plasma; In 2018 AIAA Aerospace Sciences Meeting; American Institute of Aeronautics and Astronautics: Reston, Virginia, 2018, 10.2514/6.2018-0689.

[5] Dumitrache, C.; Galant, A.; Minesi, N.; Stepanyan, S.; Stancu, G.-D.; Laux, C. O. Hydrodynamic regimes in NRP discharges (in preparation). Journal of Physics D: Applied Physics 2019.

[6] Two Regime Cooling in Flow Induced by a Spark Discharge. Bhavini Singh, Lalit K. Rajendran, Pavlos P. Vlachos, and Sally P. M. Bane. Phys. Rev. Fluids 5, 014501-Published 14 Jan. 2020.

[7] A 3-D DNS and experimental study of the effect of the recirculating flow pattern inside a reactive kernel produced by nanosecond plasma discharges in a methane-air mixture Maria Castela, Sergey Stepanyan (2017).

[8] Numerical Modeling of the Hydrodynamics Induced by Dual-Pulse Laser Plasma, Ciprian Dumitrache, Azer Yalin (2018).

[9] Mao et al 2018, “Numerical modeling of ignition enhancement of CH4/O2/He mixtures using a hybrid repetitive nanosecond and DC discharge,” doi/10.1016/j.proci.2018.05.106.

1. A method for producing gases from a dissociation of a gas mixture, comprising:
a step of injecting a gas mixture into a pulsed plasma reactor comprising a structure defining a chamber containing a first electrode and one or more other electrodes of opposite polarity facing the first electrode;
a dissociation step of the gas mixture, using isochoric discharges between the first electrode, of a given polarity, and the one or more other electrodes;
a step of releasing the produced reactive gases from the dissociation step to an area where they can be cooled down and/or separated and/or collected;
wherein the first electrode and the one or more other electrodes define an inter-electrode gap characterized by a variable inter-electrode distance and formed of an ignition area, and wherein the dissociation step comprises, in the event that the plasma produced in the reactor is blown out by a continuous stream of the gas mixture entering the reactor, a step for providing passive re-ignition of the plasma, the passive re-ignition step being performed within the ignition area in an area protected from the continuous stream of gas, the protected area resulting from the arrangement of an insulating block in the structure and having an inter-electrode distance allowing ignition of the plasma sheltered from the continuous stream of gas.

2. The method according to claim 1, wherein the step of passive re-ignition of the plasma further comprises, at the outlet of the ignition area, an entry of the plasma into a propagation area having an increasing distance and then decreasing distance between the second electrode and the structure connected to the first electrode, in the direction of propagation of the plasma, and then into a stable operating area arranged to create an electric field and having an inter-electrode distance less than the distance in the propagation area.

3. The method according to claim 1, wherein the dissociation step further comprises a plasma discharge between the first and second electrodes to produce an asymmetric shock wave.

4. The method according to claim 3, further comprising an increase in the reduced electric field intensity at one of the two electrodes to produce a reduced electric field asymmetry.

5. The method according to claim 4, further comprising heating one of the electrodes to produce a reduced electric field asymmetry.

6. The method according to claim 1, wherein the dissociation step further comprises a step for generating a high-voltage signal greater than 10 kV for controlling repetitive discharges by combining a very-high-voltage signal greater than 130 Td over short times less than 20 ns to ionize the gas and a high-voltage signal between 50 and 100 Td over long times less than 1 s to excite the molecules into excited vibrational levels.

7. A system for transforming a gas, using the production method according to claim 1, comprising:
a pulsed plasma reactor comprising a structure defining a chamber containing a first electrode and one or more other electrodes of opposite polarity facing the first electrode;
means for injecting a gas mixture into the pulsed plasma reactor so as to provide a substantially continuous inflow of gas into the pulsed plasma reactor;
a dissociation stage comprising the pulsed plasma reactor receiving the inflow of gas at the inlet, the first long electrode of a given polarity, and the one or more other electrodes of opposite polarity, facing the first electrode, the first electrode and the one or more other electrodes defining an inter-electrode gap, characterized by a variable inter-electrode distance, and arranged so as to subject the flow of gas to isochoric discharges so as to produce reactive gases;
an interface for releasing the reactive gases to an area where they can be cooled and/or separated and/or collected; and
an insulating block creating an ignition area protected from the flow of gas the inter-electrode distance of which allows a passive re-ignition of the plasma in the event that the latter is blown out by a continuous stream of the gas mixture entering the plasma reactor.

8. The system according to claim 7, wherein the pulsed plasma reactor further comprises:
an area of increasing distance and then decreasing distance between the second electrode and a structure connected to the first electrode in the direction of propagation of the plasma, known as the propagation area; and
an area of inter-electrode distance less than the distance the propagation area, known as the stable operation area, arranged to create an electric field.

9. The system according to claim 7, wherein the stable operation area is substantially parallel to the direction of the gas flow.

10. The system according to claim 7, wherein the stable operation area is substantially transverse to the direction of the gas flow.

11. The system according to claim 7, further comprising means for controlling the direction of flow of the reactive gases in the plasma discharge, the direction control means comprising means for increasing the reduced electric field at one of the two electrodes.

12. The system according to claim 11, wherein the means for increasing the reduced electric field use a point-effect electrode.

13. The system according to claim 11, wherein the means for increasing the reduced electric field use a heating mechanism included in one of the electrodes.

14. The system according to claim 7, further comprising means for generating a high-voltage signal greater than 10 kV for controlling repetitive discharges by combining a very-high-voltage signal greater than 130 Td over short times less than 20 ns to ionize the gas and a high-voltage signal between 50 and 100 Td over long times less than 1 s to excite the molecules into excited vibrational levels.

15. The system according to claim 7, wherein the system is configured to produce gaseous dihydrogen from hydrocarbon and CO2 mixtures or hydrocarbons, to inject the hydrocarbon and CO2 mixtures or of hydrocarbons at the inlet of the pulsed plasma reactor, and to collect gaseous dihydrogen at the outlet of the pulsed plasma reactor.

16. The system according to claim 15, wherein the isochoric discharges comprise nanosecond repetitively pulsed discharges.

17. The system according to claim 15, wherein the interface for releasing the reactive gases comprises:
a stage for rapid cooling of the reactive gases; and
a stage for separating the gaseous dihydrogen and carbon monoxide produced after the cooling of the reactive gases.

18. A method of using a system according to claim 7 to produce oxygen from carbon dioxide, comprising injecting carbon dioxide at the inlet of the pulsed plasma reactor and collecting oxygen at the outlet of the pulsed plasma reactor.
